(19) United States
(12) Patent Application Publication
(10) Pub. No.: US 2014/0281975 A1
(43) Pub. Date: Sep. 18, 2014

(54) SYSTEM FOR ADAPTIVE SELECTION AND PRESENTATION OF CONTEXT-BASED MEDIA IN COMMUNICATIONS

(71) Applicants: Glen J. ANDERSON, Beaverton, OR (US); Lama Nachman, San Francisco, CA (US); Lenitra M. Durham, Beaverton, OR (US); Jose K. Sia, Jr., Hillsboro, OR (US); Jared S. Bauer, Portland, OR (US)

(72) Inventors: Glen J. ANDERSON, Beaverton, OR (US); Lama Nachman, San Francisco, CA (US); Lenitra M. Durham, Beaverton, OR (US); Jose K. Sia, Jr., Hillsboro, OR (US); Jared S. Bauer, Portland, OR (US)

(21) Appl. No.: 13/832,480

(22) Filed: Mar. 15, 2013

(51) Int. Cl. G06F 3/0481

(52) U.S. Cl. CPC G06F 3/0481
USPC 715/716

(57) ABSTRACT

A system and method for adaptive selection of context-based media for use in communication includes a user communication device configured to receive and process data captured by one or more sensors and determine contextual characteristics of a user environment based on the captured data. The user communication device is configured to identify media associated with the contextual characteristics of the user environment. In particular, the identified media may correspond to a contextual characteristic specifically assigned to the media and may also include content related to the contextual characteristics of the user environment. The user communication device is further configured to display the identified media via a display of the user communication device and include the identified media in a communication to be transmitted by the user communication device if the identified media is selected for inclusion in the communication.

### FIELD

The present disclosure relates to communication and interaction, and, more particularly, to a system and method for adaptive selection of context-based media for use in communication between at least two communication devices.

### BACKGROUND

Mobile and desktop communication devices are becoming ubiquitous tools for communication between two or more remotely located persons. While some such communication is accomplished using voice and/or video technologies, a large share of communication in business, personal and social networking contexts utilizes textual technologies. In some applications, textual communications may be supplemented with graphic content in the form of avatars, animations and the like.

Modern communication devices are equipped with increased functionality, processing power and data storage capability to allow such devices to perform advanced processing. For example, many modern communication devices, such as typical “smart phones,” are capable of monitoring, capturing and analyzing large amounts data relating to their surrounding environment. Additionally, many modern communication devices are capable of connecting to various data networks, including the Internet, to retrieve and receive data communications over such networks.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a device-to-device system for adaptive selection of context-based media for use in augmented communications transmitted by a communication device consistent with various embodiments of the present disclosure;

FIG. 2 is a block diagram illustrating at least one embodiment of a user communication device of the system of FIG. 1 consistent with the present disclosure;

FIG. 3 is a block diagram illustrating at least one embodiment of an environment of the user communication device of FIGS. 1 and 2;

FIG. 4 is a block diagram illustrating a portion of the system and user communication device of FIGS. 1 and 2 in greater detail;

FIG. 5 is a block diagram illustrating another portion of the system and user communication device of FIGS. 1 and 2 in greater detail;

FIGS. 6A-6C are simplified diagrams illustrating an embodiment of the user communication device engaged in a method of assigning contextual characteristics, generally in the form of user input, with associated media to be included in communication to be transmitted by the user communication device; and

FIG. 7 is a flow diagram illustrating one embodiment of a method for adaptive selection of context-based media for use in augmented communications transmitted by a communication device consistent with the present disclosure.

### DETAILED DESCRIPTION

By way of overview, the present disclosure is generally directed to a system and method for adaptive selection of context-based media for use in communication between a user communication device and at least one remote communication device based on contextual characteristics of a user environment. The system includes a user communication device configured to receive and process data captured by one or more sensors and determine contextual characteristics of the user environment based on the captured data. The contextual characteristics may include, but are not limited to, physical characteristics of the user, including facial expressions and physical movements in the form of gestures, as well as voice input from the user.

The user communication device is configured to identify media based, at least in part, on the contextual characteristics of the user environment. The media may be from one or more sources, such as, for example, a cloud-based service and/or a local media database on the communication device. The identified media is associated with the contextual characteristics of the user environment. In particular, the identified media may correspond to a contextual characteristic specifically assigned to the media. In addition, the identified media may also include content related to the contextual characteristics of the user environment, such as, for example, subject matter of voice input from the user. The user communication device is further configured to display the identified media via a display of the user communication device and include the identified media in a communication to be transmitted by the user communication device if the identified media is selected for inclusion in the communication.

A system consistent with the present disclosure provides an intuitive means of identifying relevant media for inclusion in an active communication between communication devices based on contextual characteristics of the user environment, including recognized subject matter of voice input from a user of a communication device. The system may be configured to continually monitor contextual characteristics of the user environment, specifically during an active communication between the user communication device and at least one remote communication device, and adaptively identify and provide associated media for inclusion in the communication in real-time or near real-time. Accordingly, the system may promote enhanced interaction and foster further communication between communication devices and the associated users.

Turning to FIG. 1, one embodiment of a device-to-device system 10 for adaptive selection of context-based media for use in augmented communications transmitted by a communication device is generally illustrated. The system 10 includes a user communication device 12 communicatively coupled to at least one remote communication device 14 via a network 16. As discussed in more detail below, the user communication device 12 is configured to acquire data related to a user environment and determine contextual characteristics of the user environment based on the captured data. The user environment data may be acquired from one or more devices and/or sensors on-board the user communication device 12 and/or from one or more sensors external to the user communication device 12. The contextual characteristics may relate to the user of the communication device 12 (e.g., the user's context, physical characteristics of the user, voice input from the user and/or other sensed aspects of the user). It should be understood that the contextual characteristics may further relate to events or conditions surrounding the user of the communication device 12.

Alternatively or additionally, user environment data may be produced by one or more application programs executed by the user communication device 12, and/or by at least one external device, system or server 18. In either case, such user environment data may be acquired and processed by the user communication device 12 to determine contextual characteristics. Examples of such user environment data, but should not be limited to, still images of the user, video of the user, physical characteristics of the user (e.g., gender, height, weight, hair color, facial expressions, movement of one or more body parts of the user (e.g. gestures), etc.), activities being performed by the user, physical location of the user, audio content of the environment surrounding the user, voice input from the user, movement of the user, proximity of the user to one or more objects, temperature of the user and/or environment surrounding the user, direction of travel of the user, humidity of the environment surrounding the user, medical condition of the user, other persons in the vicinity of the user, pressure applied by the user to the user communication device 12, and the like.

The user communication device 12 is further configured to identify media based on the user contextual characteristics, and display the identified media via a display of the device 12. Identified media may include a variety of different forms of media, including, but not limited to, images, animations, audio clips, video clips. The media may be from one or more sources, such as, for example, the external device, system or server 18, a cloud-based network or service 20 and/or a local media database on the device 12. The identified media is generally associated with the contextual characteristics. In particular, the identified media may correspond to a contextual characteristic specifically assigned to the media. In addition, the identified media may also include content related to the contextual characteristics of the user environment, such as, for example, subject matter of voice input from the user.

The user communication device 12 is further configured to allow the user to select the displayed identified media to include the selected identified media in a communication transmitted by the user communication device 12 to another device or system, e.g., to the remote communication device 14 and/or to one or more subscribers, viewers and/or participants of one or more social network, blogging, gaming or other services hosted by the external computing device/system/server 18.

The user communication device 12 may be embodied as any type of device for communicating with one or more remote devices/systems/servers and for performing the other functions described herein. For example, the user communication device 12 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data, and/or to execute electronic game software and related applications. A user may use multiple different user communication devices 12 to communicate with others, and the user communication device 12 illustrated in FIG. 1 will be understood to represent one or multiple such communication devices.

The remote communication devices may likewise be embodied as any type of device for communicating with one or more remote devices/systems/servers. Example embodiments of the remote communication device 14 may be identical to those just described with respect to the user communication device 12.

The external computing device/system/server may be embodied as any type of device, system or server for communicating with the user communication device 12, the remote communication device 14 and/or the cloud-based service 20, and for performing the other functions described herein. Examples embodiments of the external computing device/system/server 18 may be identical to those just described with respect to the user communication device 12 and/or may be embodied as a conventional server, e.g., web server or the like.

The network 16 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the user communication device 12 and the remote communication device 14 between the user communication device 12 and the external computing device/system/server 18, may be, in whole or in part, a wired connection.

Generally, communications between the user communication device 12 and any such remote devices, systems, servers and/or cloud-based service may be conducted via the network 16 using any one or more, or combination, of conventional secure and/or unsecure communication protocols. Examples include, but should not be limited to, a wired network communication protocol (e.g., TCP/IP), a wireless network communication protocol (e.g., Wi-Fi®, WiMAX, Ethernet, Bluetooth®, etc.), a cellular communication protocol (e.g., Wideband Code Division Multiple Access (W-CDMA)), and/or other communication protocols. As such, the network 16 may include any number of additional devices, such as additional computers, routers, and switches, to facilitate communications. In some embodiments, the network 16 may be or include a single network, and in other embodiments the network 16 may be or include a collection of networks.

Turning to FIG. 2, at least one embodiment of a user communication device 12 of the system 10 of FIG. 1 is generally illustrated. In the illustrated embodiment, the user communication device 12 includes a processor 21, a memory 22, an input/output subsystem 24, a data storage 26, a communication circuitry 28, a number of peripheral devices 30, and one or more sensors 38. As shown, the number of peripheral devices may include, but should not be limited to, a display 32, a keypad 34, and one or more audio speakers 36. As generally understood, the user communication device 12 may include fewer, other, or additional components, such as those commonly found in conventional computer systems. Additionally, in some embodiments, one or more of the illustrative components may be incorporated in, or otherwise from a portion of, another component. For example, the memory 22, or portions thereof, may be incorporated into the processor 21 in some embodiments.

The processor 21 may be embodied as any type of processor capable of performing the functions described herein. For example, the processor may be embodied as a single or multi-core processor(s), digital signal processor, microcontroller, or other processor or processing/controlling circuit. Similarly, the memory 22 may be embodied as any type of volatile or non-volatile memory or data storage capable of performing the functions described herein. In operation, the memory 22 may store various data and software used during operation of the user communication device 12 such as operating systems, applications, programs, libraries, and drivers. The memory 22 is communicatively coupled to the processor 21 via the I/O subsystem 24, which may be embodied as circuitry and/or components to facilitate input/output operations with the processor 21, the memory 22, and other components of the user communication device 12. For example, the I/O subsystem 24 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 24 may form a portion of a system-on-a-chip (SoC) and be incorporated, along with the processor 21, the memory 22, and other components of user communication device 12, on a single integrated circuit chip.

The communication circuitry 28 of the user communication device 12 may be embodied as any communication circuit, device, or collection thereof, capable of enabling communications between the user communication device 12 and any one of the remote device 14, external device, system, server 18 and/or cloud-based service 20. The communication circuitry 28 may be configured to use any one or more communication technology and associated protocols, as described above, to effect such communication.

The display 32 of the user communication device 12 may be embodied as any one or more display screens on which information may be displayed to a viewer of the user communication device 12. The display may be embodied as, or otherwise use, any suitable display technology including, for example, a liquid crystal display (LCD), a light emitting diode (LED) display, a cathode ray tube (CRT) display, a plasma display, and/or other display technology currently known or developed in the future. Although only a single display 32 is illustrated in FIG. 2, it should be appreciated that the user communication device 12 may include multiple displays or display screens on which the same or different content may be displayed contemporaneously or sequentially with each other.

The data storage 26 may be embodied as any type of device or devices configured for short-term or long-term storage of data such as, for example, memory devices and circuits, memory cards, hard disk drives, solid-state drives, or other data storage devices. In the illustrative embodiment, the user communication device 12 may maintain one or more application programs, databases, media and/or other information in the data storage 26. As discussed in more detail below, the media for inclusion in a communication transmitted by the device 12 may stored in the data storage 26, displayed on the display 32 and transmitted to the remote communication device 14 and/or to the external device/system/server 18 in the form of images, animations, audio files and/or video files.

The user communication device 12 also includes one or more sensors 38. Generally, the sensors 38 are configured to capture data relating to the user of the user communication device 12 and/or to acquire data relating to the environment surrounding the user of the user communication device 12. It will be understood that data relating to the user may, but need not, include information relating to the user communication device 12 which is attributable to the user because the user is in possession of, proximate to, or in the vicinity of the user computing device 12. As described in greater detail herein, the sensors 38 may be configured to capture data relating to physical characteristics of the user, such as facial expression and body movement, as well as voice input from the user. Accordingly, the sensors 38 may include, for example, a camera and a microphone, described in greater detail herein.

The user communication device 12 further includes an augmenting communication module 40. As described in greater detail herein, the augmenting communication module 40 is configured to receive data captured by the one or more sensors 38 and further determine contextual characteristics of at least the user based on an analysis of the captured data. The augmenting communication module 40 is further configure to identify media associated with the contextual characteristics and further allow a user to select the identified media for inclusion in a communication to be transmitted by the device 12. The media may include, for example, local media stored in the data storage 26 and/or media from the cloud-based service 20.

The remote communication device 14 may be embodied generally as illustrated and described with respect to the user communication device 102 of FIG. 2, and may include a processor, a memory, an I/O subsystem, a data storage, a communication circuitry and a number of peripheral devices as such components are described above. In some embodiments, the remote communication device 14 may include one or more of the sensors 38 illustrated in FIG. 2, although in other embodiments the remote communication device 14 may not include one or more of the sensors illustrated in FIG. 2 and/or described above or in greater detail herein.

Turning to FIG. 3, at least one embodiment of an environment of the user communication device 12 of FIGS. 1 and 2 is generally illustrated. In the illustrated embodiment, the environment includes the augmenting communication module 40, wherein the augmenting communication module 40 includes interface modules 42 and a context management module 44. The environment further includes an internet browser module 44, one or more application programs 46, a messaging interface module 48 and an email interface module 50. As described in greater detail herein, particularly with reference to FIGS. 4 and 5, the interface modules 42 are configured to process and analyze data captured from a corresponding sensor 38 to determine one or more contextual characteristics based on analysis of the captured data. The context management module 44 is further configured to receive the contextual characteristics and identify media associated with the contextual characteristics to be included in a communication to be transmitted from the device 12 to the remote communication device 14, for example.

The internet browser module 46 is configured, in a conventional manner, to provide an interface for the perusal, presentation and retrieval of information by the user of the user communication device 12 of one or more information resources via the network 16, e.g., one or more websites hosted by the external computing device/system/server 18. The messaging interface module 50 is configured, in a conventional manner, to provide an interface for the exchange of messages between two or more remote users using a messaging service, e.g., a mobile messaging service (mms) implementing a so-called “instant messaging” or “texting” service, and/or a microblogging service which enables users to send text-based messages of a limited number of characters to wide audiences, e.g., so-called “tweeting.” The email interface module 52 is configured, in a conventional manner, to provide an interface for composing, sending, receiving and reading electronic mail.

The application program(s) 48 may include any number of different software application programs, each configured to execute a specific task, and from which user environment information, i.e., information about the user of the user communication device 12 and/or about the environment surrounding the user communication device 12, may be determined or obtained. Any such application program may use information obtained from at least one of the sensors 38, from one or more other application programs, from one or more of the user communication device modules, and/or from the external computing device/system/server 18 to determine or obtain the user environment data.

As will be described in detail below, the interface modules 42 of the augmenting communication module 40 are configured to automatically acquire, from one or more of the sensors 38 and/or from the external computing device/system/server 18 user environment data relating to occurrences of stimulus events that are above a threshold level of change for any such stimulus event. In turn, the interface modules 42 are configured to determine contextual characteristics of at least the user based on analysis of the user environment data. The context management module 44 is then configured to automatically search for and identify media associated with the contextual characteristics and display the identified media via a user interface displayed on the display 32 of the user communication device 12 while the user of the user communication device 12 is in the process of communicating with the remote communication device 14 and/or the external computing device/system/server 18 and/or the cloud-based service 20, via the internet browser module 46, the messaging interface module 50 and/or the email interface module 52.

The communications being undertaken by the user of the user communication device 12 may be in the form of mobile or instant messaging, e-mail, blogging, microblogging, communicating via a social media service, communicating during or otherwise participating in on-line gaming, or the like. In any case, the user communication device 12 is further configured to allow the user to select identified media corresponding to the contextual characteristics displayed via the user interface on the display 32, and to include the selected media in the communication to be transmitted by the user communication device 12.

FIGS. 4 and 5 generally illustrate portions of the system 10 and user communication device 12 of FIGS. 1 and 2 in greater detail. Referring to FIG. 4, the sensors 38 include a camera 54, which may include forward facing and/or rearward facing camera portions and/or which may be configured to capture still images and/or video and a microphone 56.

It should be understood that the device 12 may include additional sensors. Examples of one or more sensors on-board the user communication device 102 may include, but should not be limited to, an accelerometer or other motion or movement sensor to produce sensory signals corresponding to motion or movement of the user of the user communication device 12, a magnometer to produce sensory signals from which direction of travel or orientation can be determined, a temperature sensor to produce sensory signals corresponding to temperature of or about the device 12, an ambient light sensor to produce sensory signals corresponding to ambient light surrounding or in the vicinity of the device 12, a proximity sensor to produce sensory signals corresponding to the proximity of the device 12 to one or more objects, a humidity sensor to produce sensory signals corresponding to the relative humidity of the environment surrounding the device 12, a chemical sensor to produce sensor signals corresponding to the presence and/or concentration of one or more chemicals in the air or water proximate to the device 12 or in the body of the user, a bio sensor to produce sensor signals corresponding to an analyte of a body fluid of the user, e.g., blood glucose or other analyte, or the like.

In any case, the sensors 38 are configured to capture user environment data, including user contextual information and/or contextual information about the environment surrounding the user. Contextual information about the user may include, for example, but should not be limited to the user's presence, gender, hair color, height, build, clothes, actions performed by the user, movements made by the user, facial expressions made by the user, vocal information spoken, sung or otherwise produced by the user, and/or other context data.

The camera 54 may be embodied as any type of digital camera capable of producing still or motion pictures from which the user communication device 12 may determine context data of a viewer. Similarly, the microphone 56 may be embodied as any type of audio recording device capable of capturing local sounds and producing audio signals detectable and usable by the user communication device 12 to determine context data of a user.

As previously described, the augmenting communication module 40 includes interface modules 42 configured to receive user environment data captured by the sensors 38 and establish contextual characteristics of at least the user based on analysis of the captured data. In the illustrated embodiment, the augmenting communication module 40 includes a camera interface module 58 and a microphone interface module 60.

The camera interface module 58 is configured to receive one or more digital images captured by the camera 54. The camera 54 includes any device (known or later discovered) for capturing digital images representative of an environment that includes one or more persons, and may have adequate resolution for face analysis of the one or more persons in the environment as described herein.

For example, the camera 54 may include a still camera (i.e., a camera configured to capture still photographs) or a video camera (i.e., a camera configured to capture a plurality of moving images in a plurality of frames). The camera 54 may be configured to capture images in the visible spectrum or with other portions of the electromagnetic spectrum (e.g., but not limited to, the infrared spectrum, ultraviolet spectrum, etc.). The camera 54 may be further configured to capture digital images with depth information, such as, for example, depth values determined by any technique (known or later discovered) for determining depth values, described in greater detail herein. For example, the camera 54 may include a depth camera that may be configured to capture the depth image of a scene within the computing environment. The camera 54 may also include a three-dimensional (3D) camera and/or a RGB camera configured to capture the depth image of a scene.

The camera 54 may be incorporated within the user communication device 12 or may be a separate device configured to communicate with the user communication device 12 via wired or wireless communication. Specific examples of cameras 54 may include wired (e.g., Universal Serial Bus (USB), Ethernet, Firewire, etc.) or wireless (e.g., WiFi, Bluetooth, etc.) web cameras as may be associated with computers, video monitors, etc., mobile device cameras (e.g., cell phone or smart phone cameras integrated in, for example, the previously discussed example computing devices), integrated laptop computer cameras, integrated tablet computer cameras, etc.

Upon receiving the image(s) from the camera 54, the camera interface module 58 may be configured to identify physical characteristics of at least the user, in addition to the environment. For example, the camera interface module 58 may be configured to identify a face and/or face region within the image(s) and determine one or more facial characteristics of the user. As generally understood by one of ordinary skill in the art, the camera interface module 58 may be configured to use any known internal biometric modeling and/or analyzing methodology to identify face and/or face region with the image(s). For example, the camera interface module 58 may include custom, proprietary, known and/or after-developed face recognition and facial characteristics code (or instruction sets), hardware, and/or firmware that are generally well-defined and operable to receive a standard format image and identify, at least to a certain extent, a face and one or more facial characteristics in the image.

Additionally, the camera interface module 58 may be configured to identify a face and/or facial characteristics of a user by extracting landmarks or features from the image of the user's face. For example, the camera interface module 58 may analyze the relative position, size, and/or shape of the eyes, nose, cheekbones, and jaw, for example, to form a facial pattern.

The camera interface module 58 may further be configured to identify one or more parts of the user's body within the image(s) provided by the camera 54 and track movement of such identified body parts to determine one or more gestures performed by the user. For example, the camera interface module 58 may include custom, proprietary, known and/or after-developed identification and detection code (or instruction sets), hardware, and/or firmware that are generally well-defined and operable to receive an image (e.g., but not limited to, a RGB color image) and identify, at least to a certain extent, a user's hand in the image and track the detected hand through a series of images to determine an air-gesture based on hand movement. The camera interface module 58 may be configured to identify and track movement of a variety of body parts and regions, including, but not limited to, head, torso, arms, hands, legs, feet and the overall position of a user within a scene.

The microphone interface module 60 is configured to receive voice data of the user (as well as other vocal utterances of the user, such as laughter) captured by the microphone 56. The microphone 56 includes any device (known or later discovered) for capturing voice data of at least one person, and may have adequate digital resolution for voice analysis of the at least one person. In addition, the microphone 56 may be configured to capture ambient sounds from within the surrounding environment of the user. Such ambient sounds may include, for example, a dog barking or music playing in the background. It should be noted that the microphone 56 may be incorporated within the user communication device 12 or may be a separate device configured to communicate with the user communication device 12 via any known wired or wireless communication.

Upon receiving the voice data from the microphone 56, the microphone interface module 60 may be configured to use any known speech analyzing methodology to identify particular subject matter of the voice data. For example, the microphone interface module 60 may include custom, proprietary, known and/or after-developed speech recognition and characteristics code (or instruction sets), hardware, and/or firmware that are generally well-defined and operable to receive voice data and translate speech into text data. For example, the microphone interface module 60 may be configured receive voice data related to a sentence spoken by the user and identify one or more keywords indicative of subject matter of the sentence. Additionally, the microphone interface module 60 may be configured to identify one or more spoken commands from the user, as generally understood by one skilled in the art.

Additionally, the microphone interface module 60 may be configured to detect and extract ambient noise from the voice data captured by the microphone 56. For example, the microphone interface module 60 may include custom, proprietary, known and/or after-developed noise recognition and characteristics code (or instruction sets), hardware, and/or firmware that are generally well-defined and operable to decipher ambient noise of the voice data and identify subject matter of the ambient noise, such as, for example, identifying subject matter of audio and/or video content (e.g., music, movies, television, etc.) being presented. For example, the microphone interface module 60 may be configured to identify music playing in the environment (e.g., identify lyrics to a song), movies playing in the environment (e.g., identify lines of movie), television shows, television broadcasts, etc.

The context management module 44 is configured to receive data from each of the interface modules (58, 60). More specifically, the camera and microphone interface modules 58, 60 are configured to provide the contextual characteristics of at least the user and the surrounding environment the context management module 44. For example, the camera interface module 58 may provide data related to detected facial expressions and/or gestures of the user and the microphone interface module 60 may provide data related to detected voice commands and/or subject matter related to a user's spoken words.

Referring to FIG. 5, the context management module 44 includes a content association module 62 and a media retrieval module 64. Generally, content association module 62 is configured to analyze the contextual characteristics from the camera and microphone interface modules 58, 60 and identify media associated with the contextual characteristics. In particular, the content association module 62 may be configured to identify media corresponding to a contextual characteristic specifically assigned to the media. In the illustrated embodiment, the content association module 62 includes a mapping module 66 configured to allow the user to assign a particular media for a specific contextual characteristic, thereby essentially pairing media with a contextual characteristic. For example, the mapping module 66 may include custom, proprietary, known and/or after-developed training code (or instruction sets), hardware, and/or firmware that are generally well-defined and operable to allow a user to assign a contextual characteristic, including, but not limited to, a gesture, facial expression and voice command, to a specific media element, such as an image, video clip, audio clip, or the like. The mapping module 66 may be configured to allow a user to select media from a variety of sources, including, but not limited to locally stored media, such as within the data storage 26, or from external sources (e.g. the external device/system/server 18 and cloud-based service 20).

The content association module 62 may be configured to compare data related a received contextual characteristic of the user with data associated one or more assignment profiles 67(1)-67(n) stored in the mapping module 66 to identify media associated with contextual characteristic of the user. In particular, the content association module 62 may be configured to compare an identified gesture, facial expression or voice command with assignment profiles 67(1)-67(n) in order to find a profile that has matching gesture, facial expression or voice command. Each assignment profile 67 may generally include data related to one of a plurality of contextual characteristics (e.g. gestures, facial characteristics and voice commands) and the corresponding media to which the one contextual characteristic is assigned.

In the event that the content association module 62 finds a matching profile in the mapping module 66, by any known or later discovered matching technique, the context management module 44 may be configured to communicate with the data storage 26, the external device/system/server 18 and/or the cloud-based service 20 and search for the corresponding media to which the contextual characteristic of the matching profile was assigned by way of the media retrieval module 64.

In the event that the content association module 62 fails to find a matching profile in the mapping module 66, the context management module 44 may be configured to search for and identify media having content related to the subject matter the contextual characteristics. In the illustrated embodiment, the media retrieval module 64 may be configured to communicate with and search the data storage 26, the external device/system/server 18 and/or the cloud-based service 20 for media having content related to the subject matter of one of more contextual characteristics. For example, in the event that the user uttered a particular name of a movie, the content association module 62 may be configured to identify media having content related to the movie, such as a video clip (e.g. trailer) of the movie.

As generally understood, the media retrieval module 64 may include custom, proprietary, known and/or after-developed search and recognition code (or instruction sets), hardware, and/or firmware that are generally well-defined and operable to generate a search query related to the subject matter and search the data storage 26, the external device/system/server 18 and/or the cloud-based service 20 and identify media content corresponding to the search query and subject matter. For example, the media retrieval module 64 may include a search engine. As may be appreciated, the media retrieval module 64 may include other known searching components.

Upon identification of media associated with one or more of the contextual characteristics, the context management module 44 is configured to receive (e.g. download, stream, etc.) the identified media element. The augmenting communication module 40 further includes a media display/selection module 68 configured to display and allow selection of the identified media element on the display 32 of the user communication device 12.

The media display/selection module 68 is configured to control the display 32 to display the identified media element(s). As generally understood, in one embodiment, for example, a portion of the display area of the display 32, e.g., an identified media element display area, may be controlled to directly display only one or more identified media elements (e.g. movie clip, animation, image, audio clip, etc.).

The media display/selection module 68 is configured to include a selected identified media element(s) in a communication to be transmitted by the user communication device 12. In embodiments in which the display 32 is a touch-screen display, for example, the user communication device 12 may monitor the identified media element display area of the display 32 for detection of contact with the display 32 in the areas of the one or more displayed identified media elements, and in such embodiments the module 428 may be configured to be responsive to detection of such contact with any user environment indicator to automatically add that user environment indicator to the communication, e.g., message, to be transmitted by the user communication device. Alternatively, the module 68 may be configured to add the contacted identified media element to the communication to be transmitted by the user communication device 12 when the selects (e.g. drags, makes contact, applies pressure, etc) the contacted identified media element to the message portion of the communication.

In embodiments in which the display 32 is not a touch-screen and/or in which the user communication device includes another peripheral device which may be used to select displayed items, the module 68 may be configured to monitor such a peripheral device for selection of one or more of the displayed identified media element(s). It will be appreciated that other mechanisms and techniques are known which operate to automatically or under the control of a user duplicate, move or otherwise include a selected graphic displayed on one portion of a display at or to another portion of the display, and any such other mechanisms and/or techniques may be implemented in the media display/selection module 68 to effectuate inclusion of one or more displayed identified media elements in or with a communication to be transmitted by the user communication device 12.

Turning to FIGS. 6A-6C, simplified diagrams illustrating an embodiment of the user communication device 12 engaged in a method of assigning contextual characteristics, specifically in the form of user input, with associated media is generally illustrated. As generally illustrated in FIG. 6A, the user communication device 12 may generally include a first user interface 100a on the display 32 in which a user may select the type of contextual characteristic in which to assign to a specific media element via the mapping module 66. As shown, the user interface 100a allows the user to select from assigning a gesture, a voice command and a facial expression. In addition, the user is given the option to either select from one of a plurality of predefined gestures, voice commands and facial expressions or select to create a new gesture, voice command and facial expression.

As shown, upon selecting to create a new gesture, user interface 100a transitions to user interface 100b (transition 1) in which the camera 54 is activated and configured to capture video images of the user performing a desired gesture. The user interface 100b then transitions to user interface 100c (transition 2) upon detection and establishment of the user gesture. At this point, the user may review the created gesture and select to continue assigning the gesture to a media element of the user's choice (e.g. mapping the gesture to the media).

In the event the user selects to continue the assignment process, user interface 100c then transitions to user interface 100d (transition 3). As shown, user interface 100d provides the user with the option to select media from a variety of different sources. For example, the user may select media from a local library or database of media, such as data storage 26. The user may also enter a URL (e.g. web address) related to a particular image. For example, the URL may be associated with a web page having one or more images, video clips, animations, audio clips, etc. provided thereon. In one embodiment, the user may further be able to navigate the web page and select media from the web page that the user desires to assign the gesture to.

As shown, the user has selected to map the gesture to media stored within the local library of the user communication device 12. The user interface 100d then transitions to user interface 100e (transition 4). User interface 100e may provide the user with access to the local library of media and may present the user with thumbnails of each media, from which the user may select one of the media elements to which the gesture is to be assign. Accordingly, each time the user performs the created gesture, the device 102 is configured to automatically identify the associated media paired with the gesture.

Turning now to FIG. 7, a flowchart of one embodiment of a method 700 for adaptive selection of context-based media for use in augmented communications transmitted by a communication device is generally illustrated. The method 700 includes monitoring a user environment (operation 710) and capturing data related to the user environment, including data related to the user within the environment (operation 720). Data may be captured by one of a plurality of sensors. The data may be captured by a variety of sensors configured to detect various characteristics of the user environment and a user within. The sensors may include, for example, at least one camera and at least one microphone.

The method 700 further includes identifying one or more contextual characteristics of at least the user within the environment based on analysis of the captured data (operation 730). In particular, interface modules may receive data captured by associated sensors, wherein each of the interface modules may analyze the captured data to determine one or more of the following contextual characteristics: physical characteristics of the user, including facial expressions and physical movements in the form of gestures, as well as voice input from the user, including subject matter of the voice input.

The method 700 further includes identifying media associated with the contextual characteristics (operation 740). In particular, the identified media may correspond to a contextual characteristic specifically assigned to the media. In addition, the identified media may also include content related to the contextual characteristics. The method 700 further includes including the identified media in a communication to be transmitted by a user communication device and received by at least one remote communication device (operation 750).

While FIG. 7 illustrates method operations according various embodiments, it is to be understood that in any embodiment not all of these operations are necessary. Indeed, it is fully contemplated herein that in other embodiments of the present disclosure, the operations depicted in FIG. 7 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. In one example there is provided a system to select media for inclusion in a communication transmitted from a communication device. The system may include at least one sensor to capture data related to a user within an environment, at least one interface module to identify user characteristics based on the captured data, a context management module to identify media associated with at least one of the user characteristics, the media is provided by one or more media sources and a media display/selection module communicatively coupled to a display to allow selection of the identified media to be transmitted by the communication device.

The above example system may be further configured, wherein the at least one sensor is at least one of a camera and a microphone, the camera to capture one or more images of the user and the microphone to capture voice data from the user. In this configuration, the example system may be further configured, wherein the at least one interface module is a camera interface module to analyze the one or more images and identify physical characteristics of the user based on the analysis. In this configuration, the example system may be further configured, wherein the physical characteristics are selected from the group consisting of facial expressions of the user and movement of one of more parts of the user's body resulting in one or more user-performed gestures. In this configuration, the example system may be further configured, wherein the at least one interface module is a microphone interface module to analyze voice data from the microphone and identify at least one of voice command and subject matter of the voice data based on the analysis.

The above example system may be further configured, alone or in combination with the above further configurations, wherein the context management module includes a mapping module to allow the user to assign one of the user characteristics to corresponding media, the mapping module includes assignment profiles, wherein each assignment profile includes a user characteristic and corresponding media to which the user characteristic is assigned. In this configuration, the example system may be further configured, wherein the context management module includes a content association module to compare the identified user characteristics with each of the assignment profiles to identify an assignment profile having a user characteristic matching one of the identified user characteristics based on the comparison and further to identify corresponding media of the identified assignment profile. In this configuration, the example system may be further configured, wherein the context management module includes a media retrieval module to search for and retrieve the identified corresponding media of the identified assignment profile from the one or more media sources.

The above example system may be further configured, alone or in combination with the above further configurations, wherein the context management module includes a media retrieval module to search for and retrieve media having content related to subject matter of one of the identified user characteristics from the one or more media sources.

The above example system may be further configured, alone or in combination with the above further configurations, wherein the media is selected from the group consisting of an image, animation, audio file, video file and network link to an image, animation, audio file or video file.

The above example system may be further configured, alone or in combination with the above further configurations, wherein the one or more media sources are selected from the group consisting of a local data storage included on the communication device, an external device/system/server and a cloud-based service.

In another example there is provided a method for selecting media for inclusion in a communication transmitted from a communication device. The method may include receiving data related to a user within an environment, identifying user characteristics based on the data, identifying media associated with at least one of the user characteristics and allowing selection of the identified media and including selected identified media in a communication to be transmitted.

The above example method may be further configured, wherein the identifying media of at least one of the user characteristics includes comparing identified user characteristics with assignment profiles, each assignment profile having a user characteristic and corresponding media to which the user characteristic is assigned, identifying an assignment profile having a user characteristic matching one of the identified user characteristics based on the comparison and identifying the corresponding media of the identified assignment profile. In this configuration, the example method may further include, searching for and retrieving the identified corresponding media of the identified assignment profile from the one or more media sources.

The above example method may further include, alone or in combination with the above further configurations, searching for and retrieving media having content related to subject matter of at least one of the identified user characteristics from the one or more media sources.

In another example, there is provided at least one computer accessible medium storing instructions which, when executed by a machine, cause the machine to perform the operations of any of the above example methods.

In another example, there is provided a system arranged to perform any of the above example methods.

In another example, there is provided a system to select media for inclusion in a communication transmitted from a communication device. The system may include means for receiving data related to a user within an environment, means for identifying user characteristics based on the data, means for identifying media associated with at least one of the user characteristics and means for allowing selection of the identified media and including selected identified media in a communication to be transmitted.

The above example system may be further configured, wherein the identifying media of at least one of the user characteristics includes means for comparing identified user characteristics with assignment profiles, each assignment profile having a user characteristic and corresponding media to which the user characteristic is assigned, means for identifying an assignment profile having a user characteristic matching one of the identified user characteristics based on the comparison and means for identifying the corresponding media of the identified assignment profile. In this configuration, the example system may further include, means for searching for and retrieving the identified corresponding media of the identified assignment profile from the one or more media sources.

The above example system may further include, alone or in combination with the above further configurations, means for searching for and retrieving media having content related to subject matter of at least one of the identified user characteristics from the one or more media sources.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system to select media for inclusion in a communication transmitted from a communication device, said system comprising:
at least one sensor to capture data related to a user within an environment;
at least one interface module to identify user characteristics based on said captured data;
a context management module to identify media associated with at least one of said user characteristics, said media being provided by one or more media sources; and
a media display/selection module communicatively coupled to a display to allow selection of said identified media to be transmitted by said communication device.

2. The system of claim 1, wherein said at least one sensor is at least one of a camera and a microphone, said camera to capture one or more images of said user and said microphone to capture voice data from said user.

3. The system of claim 2, wherein said at least one interface module is a camera interface module to analyze said one or more images and identify physical characteristics of said user based on said analysis.

4. The system of claim 3, wherein said physical characteristics are selected from the group consisting of facial expressions of said user and movement of one of more parts of said user's body resulting in one or more user-performed gestures.

5. The system of claim 2, wherein said at least one interface module is a microphone interface module to analyze voice data from said microphone and identify at least one of voice command and subject matter of said voice data based on said analysis.

6. The system of claim 1, wherein said context management module comprises a mapping module to allow said user to assign one of said user characteristics to corresponding media, said mapping module comprising assignment profiles, wherein each assignment profile includes a user characteristic and corresponding media to which said user characteristic is assigned.

7. The system of claim 6, wherein said context management module comprises a content association module to compare said identified user characteristics with each of said assignment profiles to identify an assignment profile having a user characteristic matching one of said identified user characteristics based on said comparison and further to identify corresponding media of said identified assignment profile.

8. The system of claim 7, wherein said context management module comprises a media retrieval module to search for and retrieve said identified corresponding media of said identified assignment profile from said one or more media sources.

9. The system of claim 1, wherein said context management module comprises a media retrieval module to search for and retrieve media having content related to subject matter of one of said identified user characteristics from said one or more media sources.

10. The system of claim 1, wherein said media is selected from the group consisting of an image, animation, audio file, video file and network link to an image, animation, audio file or video file.

11. The system of claim 1, wherein said one or more media sources are selected from the group consisting of a local data storage included on said communication device, an external device/system/server and a cloud-based service.

12. A method for selecting media for inclusion in a communication transmitted from a communication device, said method comprising:
receiving data related to a user within an environment;
identifying user characteristics based on said data;
identifying media associated with at least one of said user characteristics; and
allowing selection of said identified media and including selected identified media in a communication to be transmitted.

13. The method of claim 12, wherein said identifying media of at least one of said user characteristics comprises:
comparing identified user characteristics with assignment profiles, each assignment profile having a user characteristic and corresponding media to which said user characteristic is assigned;
identifying an assignment profile having a user characteristic matching one of said identified user characteristics based on said comparison; and
identifying said corresponding media of said identified assignment profile.

14. The method of claim 13, further comprising searching for and retrieving said identified corresponding media of said identified assignment profile from said one or more media sources.

15. The method of claim 12, further comprising searching for and retrieving media having content related to subject matter of at least one of said identified user characteristics from said one or more media sources.

16. At least one computer accessible medium storing instructions which, when executed by a machine, cause the machine to perform operations for selecting media for inclusion in a communication transmitted from a communication device, said operations comprising:
receiving data related to a user within an environment;
identifying user characteristics based on said data;
identifying media associated with at least one of said user characteristics; and
allowing selection of said identified media and including selected identified media in a communication to be transmitted.

17. The computer accessible medium of claim 16, wherein said identifying media of at least one of said user characteristics comprises:
comparing identified user characteristics with assignment profiles, each assignment profile having a user characteristic and corresponding media to which said user characteristic is assigned;
identifying an assignment profile having a user characteristic matching one of said identified user characteristics based on said comparison; and
identifying said corresponding media of said identified assignment profile.

18. The computer accessible medium of claim 17, further comprising searching for and retrieving said identified corresponding media of said identified assignment profile from said one or more media sources.

19. The computer accessible medium of claim 16, further comprising searching for and retrieving media having content related to subject matter of at least one of said identified user characteristics from said one or more media sources.
